(19) United States
(12) Patent Application Publication
(10) Pub. No.: US 2006/0057460 A1
(43) Pub. Date: Mar. 16, 2006

(54) Battery pack

(76) Inventors: Wolf Matthias, Stuttgart (DE); Marcin Rejman, Wailblingen (DE)

Correspondence Address: STRIKER, STRIKER & STENBY, 103 EAST NECK ROAD, HUNTINGTON, NY, 11743, US

(21) Appl. No.: 11/208,867

(22) Filed: Aug. 22, 2005

(30) Foreign Application Priority Data
Sep. 10, 2004 (DE) 10 2004 043828.5

(51) Int. Cl. H01M 2/02

(52) U.S. Cl. 429/175; 429/149

(57) ABSTRACT

A battery pack for supplying power to an electrical appliance, in particular a power tool, has a housing which at least partly comprises plastic and holds at least one battery cell, wherein the plastic is a polyethylene (PE) with a density of more than 0.93 g/cm³

### BACKGROUND OF THE INVENTION

The invention relates to a battery pack for supplying power to an electrical appliance.

The terms battery cell and battery pack used here are also intended to include rechargeable current-storing means (accumulators) and accumulator packs.

Battery packs for supplying power to electrical appliances, such as handheld power tools, typically have housings that for the most part comprise plastic materials. Plastic materials typically used for battery pack housings include acrylonitrile-butadiene-styrene (ABS), polycarbonate (PC), or polyamide (PA), such as PA6 or PA12. These plastic materials have good mechanical properties and a thermal conductivity sufficient to make them suitable for use as battery pack housings for most battery cells currently available on the market.

However, the development of newer battery cells is moving in the direction of increasing the power conversion, making the power loss also greater, so that more heat is released in the interior of the housing and must be dissipated faster to the environment, to prevent overheating of the battery cells. Since the housing of battery packs is typically tightly closed, to prevent moisture from entering it, the heat dissipation must be done through the wall of the housing. With a thermal conductivity of 0.17 W/mK (ABS), 0.21 W/mK (PC) and 0.29 W/mK (PA6) according to DIN 52612, the aforementioned typical materials for battery pack housings lack any further reserves, however, so that solutions to improve heat dissipation must be looked for.

From the literature, a great number of plastic materials, some with considerably greater thermal conductivities, are indeed known. However, these plastic materials are mostly unsuited for battery pack housings, either because they lack adequate mechanical properties, or they are simply too expensive for this intended use.

### SUMMARY OF THE INVENTION

Accordingly, it is an object of the present invention to provide a battery pack, which is a further improvement of the existing battery packs.

In keeping with these objects and with others which will become apparent hereinafter, one feature of the present invention resides, briefly stated, in a battery pack for supplying power to an electrical appliance, comprising a housing which at least partly comprises plastic; at least one battery cell held by said housing, said plastic being a polyethylene with a density of more than 0.93 g/cm³.

When the battery pack is designed in accordance with the present invention it offers the advantage that not only does it have an adequate thermal conductivity for dissipating even the heat generated in the housing interior by high-power batteries as well as satisfactory mechanical properties for use as a battery pack housing material. It is moreover quite inexpensive and can be manufactured using conventional molding processes.

Surprisingly, it has been found that polyethylene, which until now has been used above all as bulk plastic but used less often for high-grade technical articles, is especially suitable as material for battery pack housings, because its thermal conductivity is considerably higher than that of the conventional battery pack housing materials recited at the outset, since it is hardly worse than those in terms of most of the strength properties demanded or desired for battery packs, and it has an even greater breaking strength, and because it is furthermore extremely inexpensive.

The greater thermal conductivity of polyethylene is surprising in the sense that other unmodified technical polyolefins do not have a comparable thermal conductivity. For instance, polypropylene (PP), with a value of 0.22 W/mK, has a thermal conductivity that is only insignificantly higher than that of polycarbonate (PC) and considerably less than that of polyamide 6 (PA6). Depending on the type of polyethylene, there are furthermore considerable differences in thermal conductivity; for low-density polyethylene (PE-LD), at approximately 0.3 W/mK, this thermal conductivity is the least, while for high-density polyethylene (PE-HD) and high-molecular polyethylene (PE-HMW) and ultrahigh-molecular polyethylene (PE-UHMW), it is approximately 0.4 to 0.42 W/mK.

As material for the battery pack housings of the invention, high-density polyethylene (PE-HD) is preferably used, since its mechanical properties, such as breaking strength, are better, with at the same time lower material costs, than those of high-molecular polyethylene (PE-HMW) and ultrahigh-molecular polyethylene (PE-UHMW) and are more than satisfactory for battery pack housings.

A further advantage of using high-density polyethylene, with thermal conductivity of approximately 0.4 to 0.42 W/mK, is that this thermal conductivity is approximately equivalent to the maximum thermal conductivity of the battery cell material itself. While insulating air gaps between the housing wall and the cell are avoided, this means that the risk of overheating of the cell cannot necessarily be reduced by further increasing the thermal conductivity of the housing material, because then the dissipation of the heat out of the cell represents the limiting factor, in terms of the risk of overheating, for the maximum power conversion in the cell.

For preventing insulating air gaps between the housing wall and the cells, a further preferred feature of the invention provides that an outer wall of the housing, surrounding the battery cell, rests with at least half of its inner wall surface against an adjacent circumferential face of the battery cell. Because of such a large-area contact of the circumferential face of the battery cell, or of each battery cell, with the outer housing wall, air-filled interstices between the cell or cells and the outer wall are avoided as much as possible; as a result, the heat transfer from the cell or each cell into the housing wall is improved, and thus the heat resistance between the battery cells and the environment can be reduced.

While in battery packs with a single-cell cross section, for one or more cylindrical battery cells stacked one above the other, a form-locking contact between the circumferential face of the cell and the housing wall can be provided for over the entire circumference of the cell, this is not possible in battery packs with a plurality of cylindrical battery cells inserted into the housing side by side, and in that case it is therefore expediently provided that between adjacent battery cells, the housing wall has wall portions that snap inward, in order to increase the contact area as much as possible and to create a larger outer surface area.

In order also to avoid the occurrence of thin air gaps between the diametrically opposed contact faces of the battery cells and the housing wall, the battery cells and the outer housing wall are preferably pressed against one another in the region of the contact faces, as a result of which the heat transfer to the housing wall can be improved still further. This contact pressure can expediently be attained by means of an elastic deformation of the polyethylene material of the housing upon insertion of the cells, for instance, in battery packs with a plurality of cylindrical battery cells inserted side by side into the housing, preferably by elastic deformation of wall portions that snap inward between two adjacent cells. Alternatively, for the same purpose, after the cells have been inserted, a core can be introduced into the nip that remains free between adjacent cells; this core presses these cells, or some of these cells, against a region of the outer housing wall diametrically opposite the core.

Since the scratch resistance of high-density polyethylene (PE-HD) is not quite that of the conventional battery pack housing materials mentioned at the outset, fillers in the form of powdered or chiplike substances with a particle size of less than 20 μm and preferably less than 10 μm can be added into the plastic material of the housing in the manufacture of the housing. By a suitable choice of the fillers and their proportion by weight or volume in the plastic material, the thermal conductivity of the plastic material of the housing can furthermore be increased somewhat as needed, or adapted to the thermal conductivity of the battery cells themselves, for instance by using fillers in the form of metal powders or powdered metal oxides, such as aluminum or aluminum oxides.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWING

FIG. 1 is a top view on a battery pack having a plurality of battery cells, in accordance with the present invention.

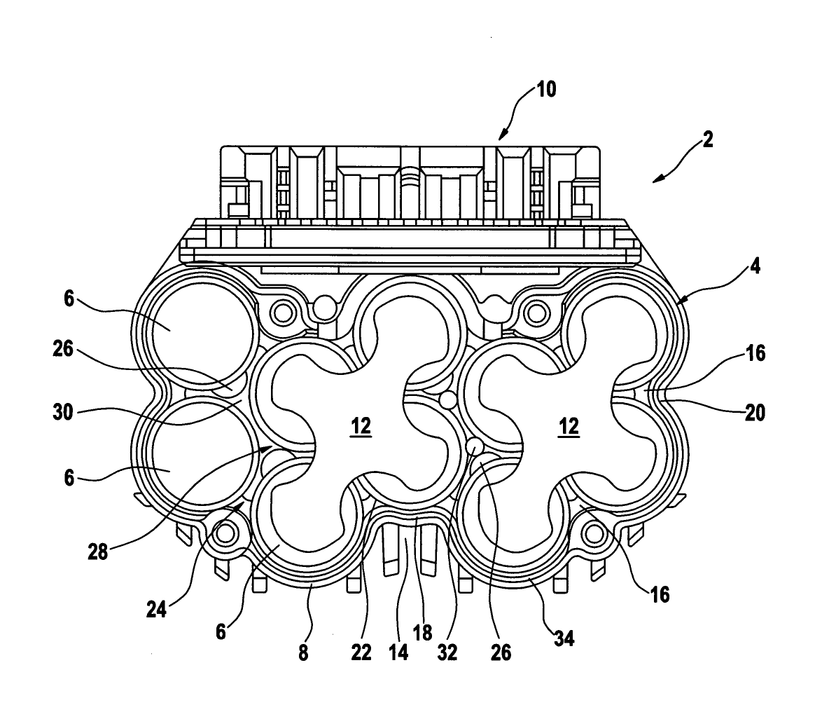

### DESCRIPTION OF THE PREFERRED EMBODIMENTS

The battery pack 2 shown in the drawing serves as a power supply for an electrical appliance, such as a handheld power tool. It substantially comprises a housing 4 that is open on its upper face end, one or more layers of battery cells 6 placed side by side in the housing 4 (only the uppermost layer is visible in the drawing), and a closure (not shown), which closes the housing 4 on the face end of the uppermost layer of cells 6. The closure, as a rule formed by part of the electrical appliance, includes two contacts that come into contact with connection contacts of the battery pack 2 when the housing 4 is closed in order to connect series- or parallel-connected cells 6, accommodated in the housing 4, to a current circuit of the consumer of the electrical appliance.

The housing is produced in one piece by injection molding from high-density polyethylene (PE-HD). Besides a bottom wall (not visible) and a circumferential wall 8, it includes a locking and connection part 10, formed onto one side of the circumferential wall 8 and not described further below, for detachable fastening of the battery pack 2 to the electrical appliance and for making the electrical connection between the cells 6 and a current circuit of the consumer of the electrical appliance. The high-density polyethylene (PE-HD) used to produce the housing 4 has a density of approximately 0.96 g/cm³, according to ISO 1183; a thermal conductivity of approximately 0.42 W/mK, according to DIN 52612; and a modulus of elasticity in tension of approximately 1350 MPa, according to ISO 527.

In the battery pack 2 shown, the housing contains a total of ten cylindrical battery cells 6 in each layer of cells 6, which are placed side by side in the form of five rows, each of two cells 6; the cells 6 of adjacent rows are offset in alternation to the left and right in the transverse direction, for the sake of optimal space utilization. Above the upper face ends of the cells 6, two cell connectors 12 of cross-shaped outline and made from an electrically conductive metal sheet are provided, which each connect poles of the same name of four adjacent cells 6 to one another.

To adapt the circumferential wall 8 of the housing 4 as closely as possible to the shape of the outer outline of the composite unit of cells 6 of each layer, this circumferential wall 8 is shaped in such a way, in the gaps 14 between the outer cells 6 that are formed by the offset of the cells of adjacent rows, of two spaced-apart rows of cells and in nips 16, widening in the outward direction, between two adjacent cells 6, that it has wall portions 18 and 20 that snap inward into the gaps 14 and the nips 16, respectively.

By means of this adaptation, on the one hand the area of the contact face between the cells 6 and the circumferential wall 8 can be maximized, so that despite the cylindrical cross sections of the cells 6, this wall, over at least half of its circumference rests against the circumferential faces 22 of battery cells 6. On the other hand, air-filled insulating interstices between the circumferential faces 22 of the cells 6 and the circumferential wall 8 can be decreased in size and the outer surface area of the housing 4 can be increased in size, thus further improving the heat dissipation out of the cells 6 to the environment.

One electrically insulating spacer 24 is located in the interstices between the cells 6 of each layer. It keeps the diametrically opposed circumferential faces 22 of adjacent cells 6 at a slight spacing from one another, for instance to prevent short circuits caused by damage from vibration to the insulation of the cells 6. The spacer 24 comprises an elastically yielding bandlike body of only slight wall thickness, which is embodied with double walls; it conforms closely to the circumferential faces 22 of some of the cells 6, and with the circumferential faces 22 of other cells, it defines a respective void 26 in the shape of a half moon. In the nips 28 between three adjacent cells 6 located in the triangle, the double-walled spacer 24 defines a void 30 of approximately triangular cross section, which adjoins one of the voids 26 of half-moon-shaped cross section.

After the insertion of the cells 6 into the housing 4, cylindrical cores 32 can be introduced into all or some of the voids 30; the outer cross-sectional dimensions of these cores are somewhat greater than the inner cross-sectional dimensions of the voids 30. The introduction of the cores 32 is enabled by an elastic deformation of the spacer 24 in the region of the rounded walls of the voids 26. After the cores 32 have been introduced, they press the cells 6 apart, and these cells, diametrically opposite the cores 32, are pressed by their cylindrical circumferential faces 22 against adjacent, complementary portions 34 of the circumferential housing wall 8, so that they press against this wall by form locking and without any air gap. The inherent elasticity of the plastic material of the circumferential wall 8 contributes to this and moreover assures compensation for any existing diameter tolerances among the cells 6.

Although in the battery pack 2 shown the battery cells 6 are embodied as monocells of circular cross section, it is understood that the housing 4 of the battery pack 2, if cells 6 of other cross-sectional shapes are used, has a design adapted to them. Preferably, the battery pack 2 is used for lithium-ion battery cells 6.

It will be understood that each of the elements described above, or two or more together, may also find a useful application in other types of constructions differing from the types described above.

While the invention has been illustrated and described as embodied in a battery pack, it is not intended to be limited to the details shown, since various modifications and structural changes may be made without departing in any way from the spirit of the present invention.

Without further analysis, the foregoing will so fully revel the gist of reveal present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A battery pack for supplying power to an electrical appliance, comprising a housing which at least partly comprises plastic; at least one battery cell held by said housing, said plastic being a polyethylene with a density of more than 0.93 g/cm³.

2. A battery pack as defined in claim 1, wherein said plastic is a high density polyethylene.

3. A battery pack as defined in claim 1, wherein said housing has at least one boundary wall which surrounds said battery cell and comprises said polyethylene.

4. A battery pack as defined in claim 3, wherein said boundary wall, along at least half of a wall area, rests against said battery cell.

5. A battery pack as defined in claim 3, wherein said boundary wall and said battery cell are pressed against one another.

6. A battery pack as defined in claim 1, wherein said housing holds a plurality of said battery cells; and further comprising a core inserted into said housing and located between adjacent ones of said battery cells, said core pressing said battery cells.

7. A battery pack as defined in claim 6, wherein said core is arranged so as to press said battery cells in a manner selected from the group consisting of pressing said battery cells against one another, pressing said battery cells against an adjacent outer boundary wall of said housing, and both.

8. A battery pack as defined in claim 1, wherein said housing holds a plurality of said battery cells, said housing having an outer boundary wall with wall portions snapping inwards between adjacent ones of said battery cells.

9. A battery pack as defined in claim 1, wherein said polyethylene includes at least one filler.

10. A battery pack as defined in claim 9, wherein said filler is a filler selected from the group consisting of a powdered mineral filler and a powdered metal filler.

11. A battery pack as defined in claim 9, wherein said filler has a particle size of less than 20 μm.

12. A battery pack as defined in claim 11, wherein said filler has a particle size of less than 10 μm
